(19) United States
(12) Patent Application Publication
(10) Pub. No.: US 2012/0160227 A1
(43) Pub. Date: Jun. 28, 2012

(54) WAFER SPLITTING APPARATUS AND WAFER SPLITTING PROCESS

(75) Inventors: Chien-Sen Weng, Hsinchu County (TW); Meng-Yeng Xing, Miaoli County (TW); Wei-Chang Yu, Kaohsiung City (TW); Chih-Sheng Chen, New Taipei City (TW); Yu-Ching Chang, Miaoli County (TW)

(73) Assignee: LEXTAR ELECTRONICS CORP., Hsinchu (TW)

(21) Appl. No.: 13/043,476

(22) Filed: Mar. 9, 2011

(30) Foreign Application Priority Data
Dec. 27, 2010 (TW) 99146138

(51) Int. Cl. B28D 5/04

(52) U.S. Cl. 125/23.01

(57) ABSTRACT

A wafer splitting apparatus suitable for splitting a plurality of chip regions of a wafer into a plurality of independent dice is provided. The wafer splitting apparatus includes a splitting knife body and at least a vibrating hammer. The splitting knife body is disposed at one side of the wafer, and has a first surface facing the wafer. The first surface stretches over a plurality of chip regions in all extending directions of the first surface passing through a center of the first surface. The splitting knife body is disposed between the wafer and the vibrating hammer, and the vibrating hammer is suitable for knocking the splitting knife body in a direction toward the wafer to make the splitting knife body move toward the wafer, so as to split the chip regions of the wafer into a plurality of independent dice. A wafer splitting process is also provided.

### CROSS-REFERENCE TO RELATED APPLICATION

This application claims the priority benefit of Taiwan application serial no. 99146138, filed Dec. 27, 2010. The entirety of the above-mentioned patent application is hereby incorporated by reference herein and made a part of this specification.

### BACKGROUND OF THE INVENTION

1. Field of the Invention

The invention relates to a wafer splitting apparatus and a wafer splitting process and more particularly to a wafer splitting apparatus and a wafer splitting process capable of reducing process time.

2. Description of Related Art

Light emitting diodes (LEDs) are semiconductor devices. Light emitting chips are mainly fabricated using compounds of group III-V elements, for example, gallium phosphide (GaP), gallium nitride (GaN) or gallium arsenide (GaAs). Moreover, LEDs emit light by converting electric energy into light energy. In details, currents are applied to compound semiconductors of LEDs so as to release energy in the form of light through the combination of electrons and holes. Since the light emitting phenomenon of LEDs does not occur through thermo-luminescence or discharge-luminescence, the lifespan of LEDs can be longer than one hundred thousand hours. LEDs further include advantages such as fast responding speed, compact volume, energy saving, low pollution, high reliability, suitable for mass production, and so on. Thus, LEDs can be widely applied in various fields, for instance, large display boards, traffic lights, cellular phones, scanners, light sources of fax machines, flat lamps and the like. LEDs have also become the mainstream for indoor illumination.

In the process of fabricating LED chips, each of a plurality of chip regions in a wafer is separated to form a plurality of independent LED chips. However, in conventional technology, splitting is time consuming as the process is usually performed cut by cut using a knife having a single knife edge. When the size of the wafer is larger or the number of chip regions to be split is higher, the process further requires more time and higher machine fabrication cost. Therefore, one of the key points to focus for researchers is to develop a wafer splitting apparatus and a wafer splitting process capable of reducing process time.

### SUMMARY OF THE INVENTION

The invention is directed to a wafer splitting apparatus capable of reducing the time required for splitting a wafer.

The invention is directed to a wafer splitting process which is more time-saving.

An embodiment of the invention provides a wafer splitting apparatus suitable for splitting a plurality of chip regions in a wafer into a plurality of independent dice. The wafer splitting apparatus includes a splitting knife body and at least one vibrating hammer. The splitting knife body is disposed at one side of the wafer and has a first surface facing the wafer. The first surface stretches over a plurality of chip regions of the wafer in all extending directions of the first surface passing through a center of the first surface. The splitting knife body is disposed between the wafer and the vibrating hammer. The vibrating hammer is suitable for knocking the splitting knife body in a direction toward the wafer for the splitting knife body to move toward the wafer so as to split the chip regions into the dice.

An embodiment of the invention provides a wafer splitting process including the following steps. A wafer is provided, where the wafer has a plurality of chip regions. A splitting knife body is knocked by at least one vibrating hammer in a direction toward the wafer for the splitting knife body to move toward the wafer and split the chip regions into a plurality of independent dice. The splitting knife body has a first surface facing the wafer and the first surface stretches over the chip regions of the wafer in all extending directions of the first surface passing through a center of the first surface.

In light of the foregoing, the first surface of the splitting knife body in the present embodiment stretches over the chip regions of the wafer in all the extending directions of the first surface passing through the center of the first surface. Thus, the splitting knife body of the present embodiment is capable of splitting the chip regions on the wafer into a plurality of dice simultaneously so as to save the fabrication time of the dice efficiently. Accordingly, the fabrication cost of the dice in the embodiments of the invention can be reduced effectively.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the invention.

FIG. 1 illustrates a schematic diagram of a wafer splitting apparatus according to a first embodiment of the invention.

FIG. 2 illustrates a schematic top view of a knife edge according to the first embodiment of the invention.

FIG. 3 and FIG. 5 respectively illustrate schematic diagrams of a wafer splitting apparatus according to an embodiment of the invention.

FIG. 4 and FIG. 6 respectively illustrate schematic top views of a knife edge according to an embodiment of the invention.

FIGS. 7A to 7C illustrate a schematic diagram of a wafer splitting process according to the first embodiment of the invention.

FIG. 8 illustrates one of the steps in the wafer splitting process according to the first embodiment of the invention.

FIG. 9 illustrates a schematic diagram of a wafer splitting apparatus according to a second embodiment of the invention.

FIGS. 10A to 10C illustrate a schematic diagram of a wafer splitting process according to the second embodiment of the invention.

### DESCRIPTION OF EMBODIMENTS

### First Embodiment

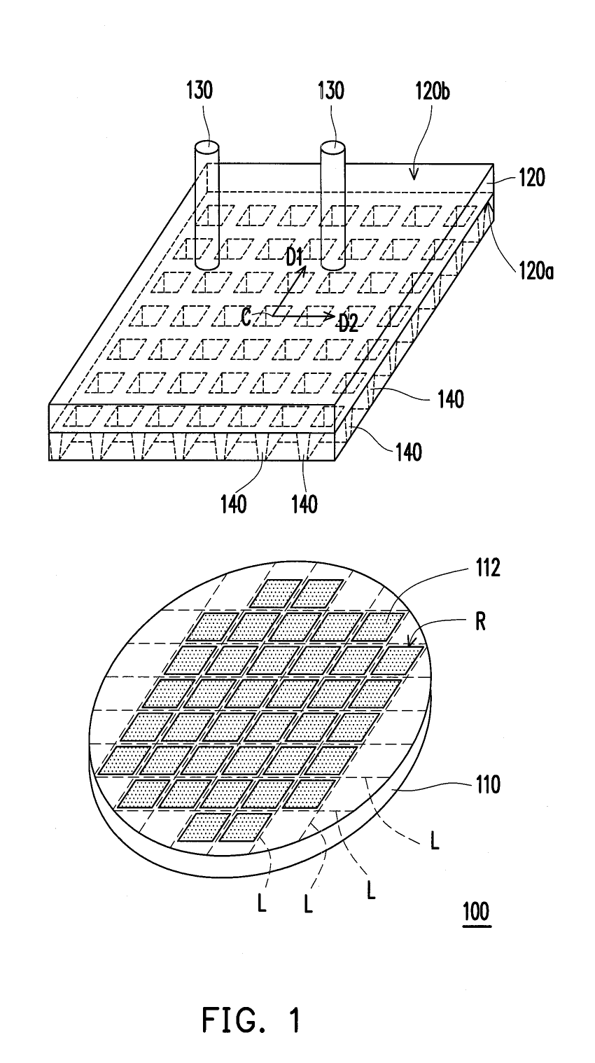

FIG. 1 illustrates a schematic diagram of a wafer splitting apparatus according to a first embodiment of the invention. Referring to FIG. 1, a wafer splitting apparatus 100 of the present embodiment is suitable for splitting a plurality of chip regions R in a wafer 110 into a plurality of independent dice 112. The wafer splitting apparatus 100 of the present embodiment includes a splitting knife body 120 and at least one vibrating hammer 130. In the present embodiment, the splitting knife body 120 is disposed at one side of the wafer 110 and has a first surface 120a facing the wafer 110. The first surface 120a stretches over a plurality of chip regions R of the wafer 110 in all extending directions of the first surface 120a passing through a center C of the first surface 120a.

For example, as shown in FIG. 1, the first surface 120a stretches over seven chip regions R of the wafer 110 in an extending direction D1 of the first surface 120a passing through the center C of the first surface 120a. The first surface 120a stretches over six chip regions R of the wafer 110 in an extending direction D2 of the first surface 120a passing through the center C of the first surface 120a. Similarly, the first surface 120a stretches over n chip regions R of the wafer 110 in another extending direction of the first surface 120a passing through the center C of the first surface 120a. Herein, n is an integer greater than or equal to 2. In the present embodiment, the first surface 120a of the splitting knife body 120 can stretch over all of the chip regions R in the wafer 110. However, the invention is not limited thereto, in other embodiments, the first surface 120a of the splitting knife body 120 can also stretch over at least four chip regions R arranged in an array in the wafer 110.

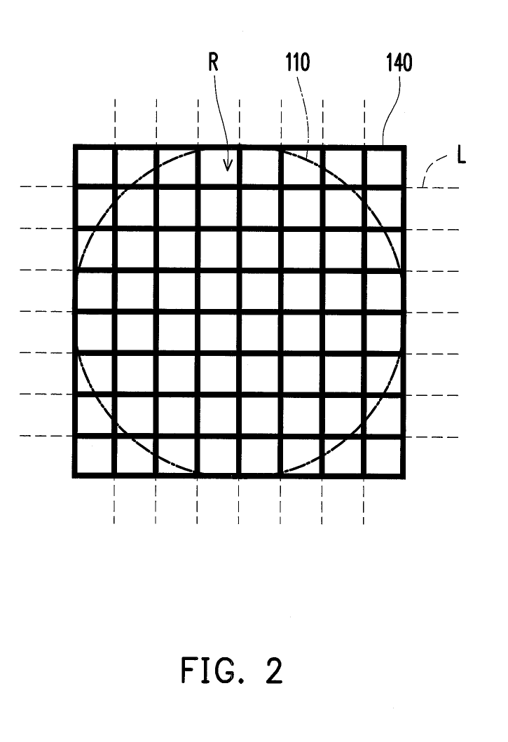

FIG. 2 illustrates a schematic top view of a knife edge in the first embodiment taken from a second surface 120b opposite to the first surface 120a. Referring to FIGS. 1 and 2, the wafer splitting apparatus 100 of the first embodiment of the invention further includes a plurality of knife edges 140 disposed on the first surface 120a. When the splitting knife body 120 moves toward the wafer 110, the knife edges 140 knock on a plurality of boundaries of the wafer regions R. In details, in the present embodiment, the knife edges 140 are in grids as depicted in FIG. 2. It should be noted that when the splitting knife body 120 moves toward the wafer 110, the knife edges 140 knock on all boundary lines L of the chip regions R. Hence, when the knife edges 140 knock on all of the boundary lines L in the chip regions R, all of the chip regions R in the wafer 110 are split into a plurality of independent dice 112 at once. That is, a plurality of independent dice 112 can be split simultaneously through the wafer splitting apparatus 100 of the present embodiment without the multiple splitting processes carried out in conventional technology.

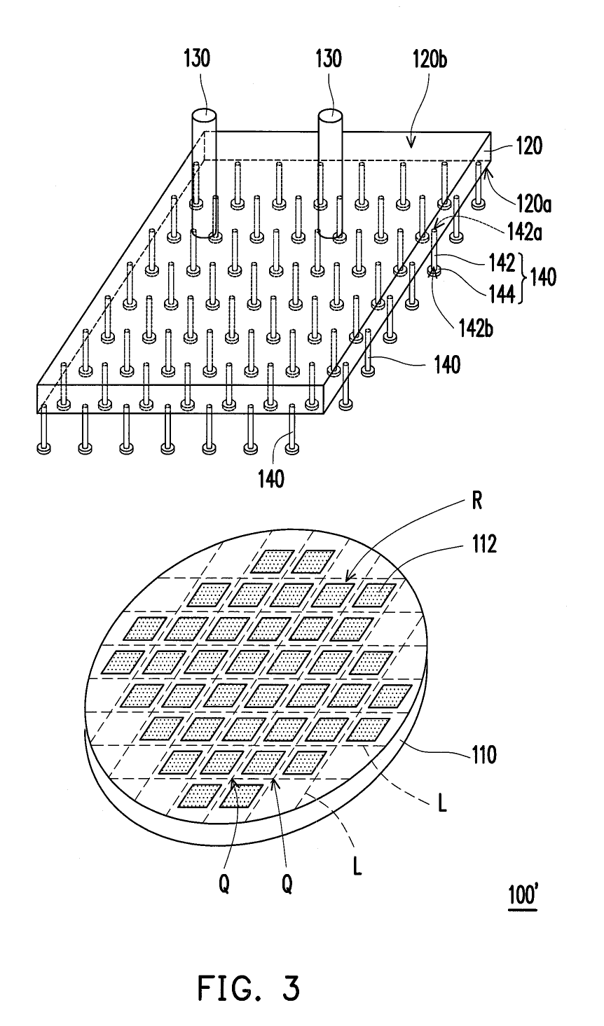

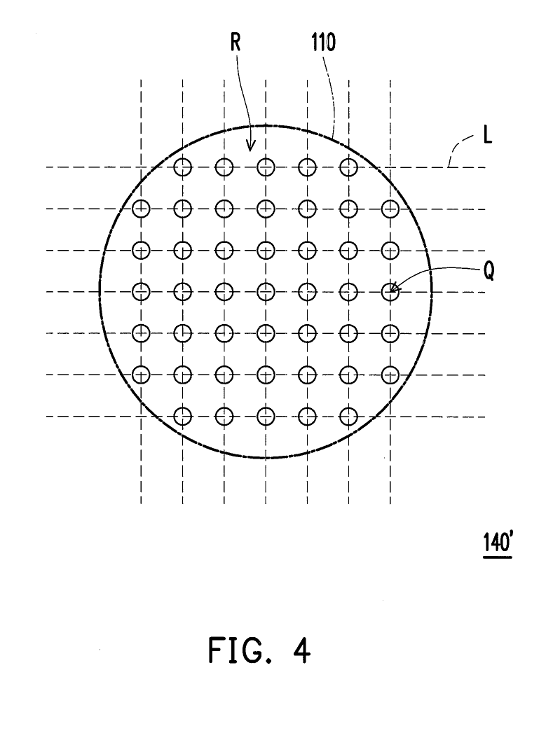

FIG. 3 illustrates a schematic diagram of a wafer splitting apparatus in another embodiment of the invention. FIG. 4 illustrates a schematic top view of a knife edge in another embodiment of the invention. Referring to FIGS. 3 and 4, a wafer splitting apparatus 100′ in this embodiment of the invention is similar to the wafer splitting apparatus 100 in the first embodiment. However, a knife edge 140′ in this embodiment of the invention is different from the knife edges 140 of the first embodiment. The knife edge 140′ of this embodiment of the invention is in dots and when the splitting knife body 120 moves toward the wafer 110, the knife edge 140′ knocks on intersection points Q of all of the boundary lines L of the chip regions R. For instance, the knife edge 140′ of this embodiment of the invention includes a circular rod 142 and a circular plate 144. One end 142a of the circular rod 142 is disposed on the first surface 120a and another end 142b of the circular rod 142 is connected to the circular plate 144. It should be noted that when the splitting knife body 120 moves toward the wafer 110, the circular plate 144 knocks on the intersection points Q of all of the boundary lines L of the chip regions R as depicted in FIG. 4. When the knife edge 140′ knocks on the intersection points Q of all the boundary lines L in the chip regions R, all of the chip regions R in the wafer 110 are split into a plurality of independent dice 112 at once. In other words, a plurality of independent dice 112 can be split simultaneously using the wafer splitting apparatus 100′ such that the time and cost for fabricating the dice 112 can be saved. In other embodiments, the knife edge 140′ can also include a circular rod 142 only. The knife edge 140′ only including the circular rod 142 and the knife edge 140′ including both the circular rod 142 and the circular plate 144 can have the same function.

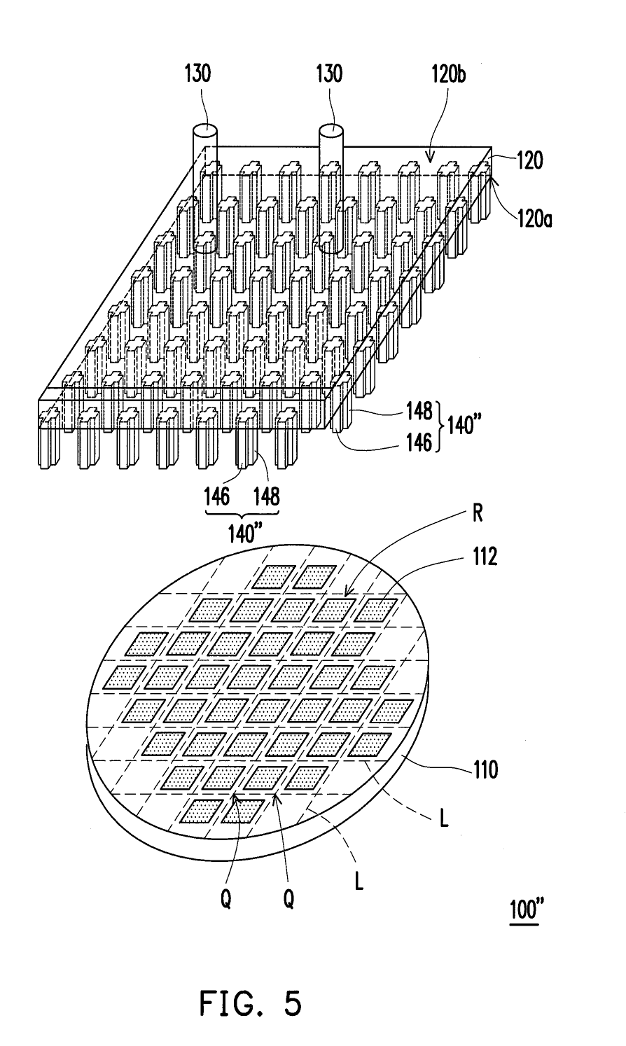

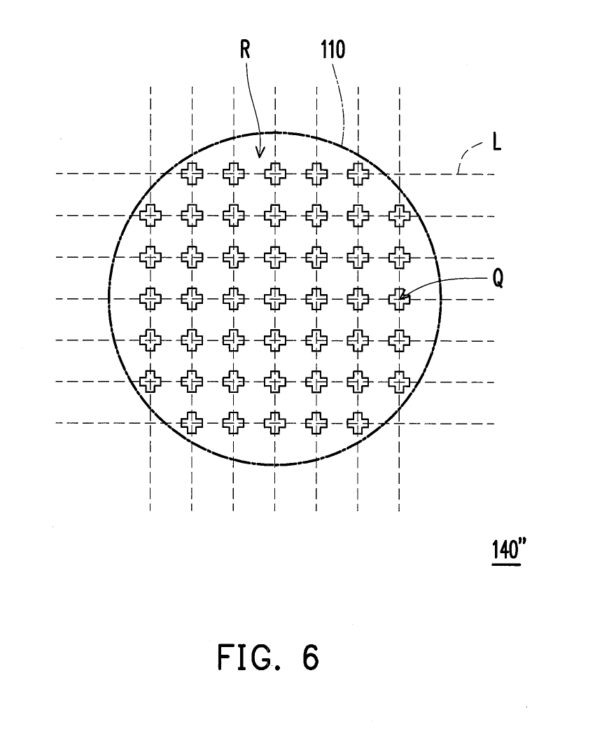

FIG. 5 illustrates a schematic diagram of a wafer splitting apparatus 100″ in another embodiment of the invention. FIG. 6 illustrates a schematic top view of a knife edge in FIG. 5. Referring to FIGS. 5 and 6, a wafer splitting apparatus 100″ in this embodiment of the invention is similar to the wafer splitting apparatus 100 in the first embodiment. However, a plurality of knife edges 140″ in this embodiment of the invention is different from the knife edges 140 of the first embodiment. The knife edges 140″ of this embodiment of the invention are in cross-shaped form and when the splitting knife body 120 moves toward the wafer 110, the knife edges 140″ knock on intersection points Q of all of the boundary lines L in the chip regions R. For instance, each of the knife edges 140″ in this embodiment of the invention includes a first portion 146 and a second portion 148. The first portion 146 and the second portion intersect and are connected to each other. The first portion 146 and the second portion 148 include a right angle, for example, so that the knife edge 140″ constituted by the first portion 146 and the second portion 148 has a cross-section, parallel to the wafer 110, in cross-shaped form. It should be noted that when the splitting knife body 120 moves toward the wafer 110, the cross-shaped cross-section knocks on the intersection points Q of all of the boundary lines L in the chip regions R. When the knife edges 140″ knock on all of the intersection points Q of the boundary lines L in the chip regions R, all of the chip regions R in the wafer 110 are split into a plurality of independent dice 112 at once. In other words, a plurality of independent dice 112 can be split simultaneously using the wafer splitting apparatus 100″ such that the time and cost for fabricating the dice 112 can be saved.

In the present embodiment, the splitting knife body 120 is disposed between the wafer 110 and the vibrating hammer 130. The vibrating hammer 130 is suitable for knocking the splitting knife body 120 in a direction toward the wafer 110 for the splitting knife body 120 to move toward the wafer 110 so as to split the chip regions R into the dice 112. In the present embodiment, the number of vibrating hammers 130 is, for example, plural (two vibrating hammers 130 are shown in the figure as an example). The splitting knife body 120 has a second surface 120b facing the vibrating hammers 130. The vibrating hammers 130 are substantially suitable for knocking on the second surface 120b simultaneously and dispersively.

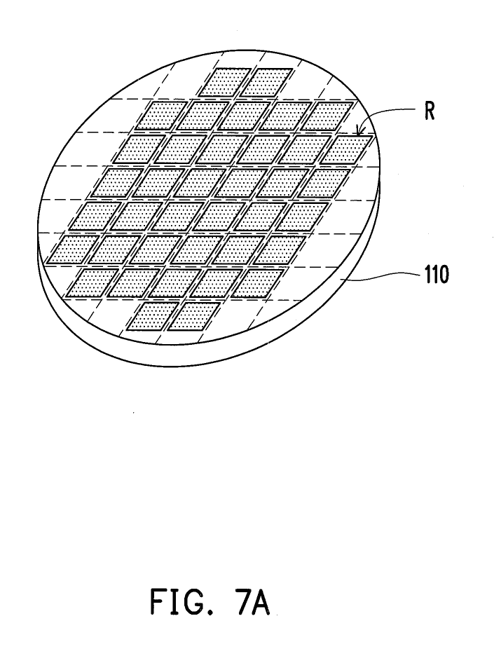

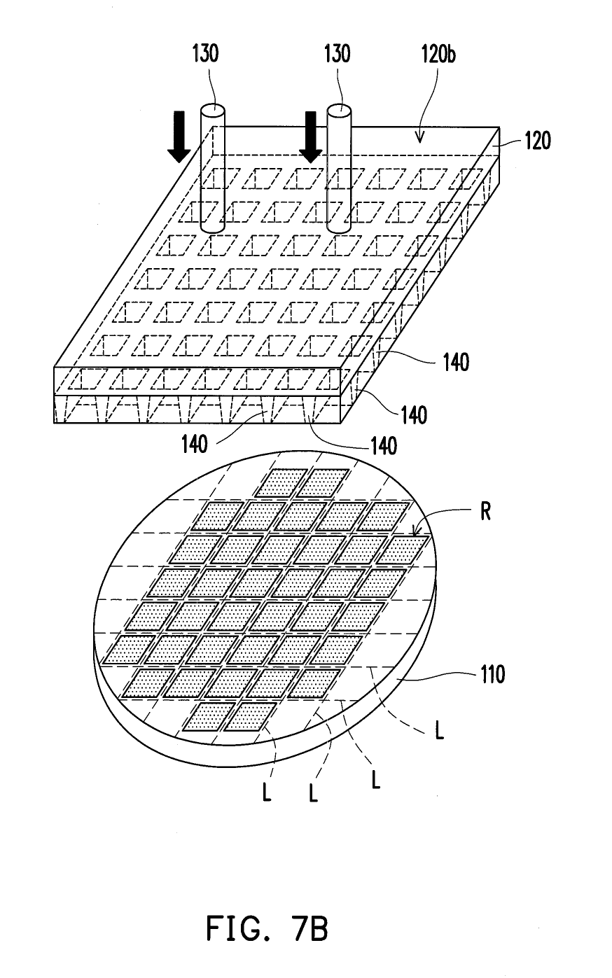

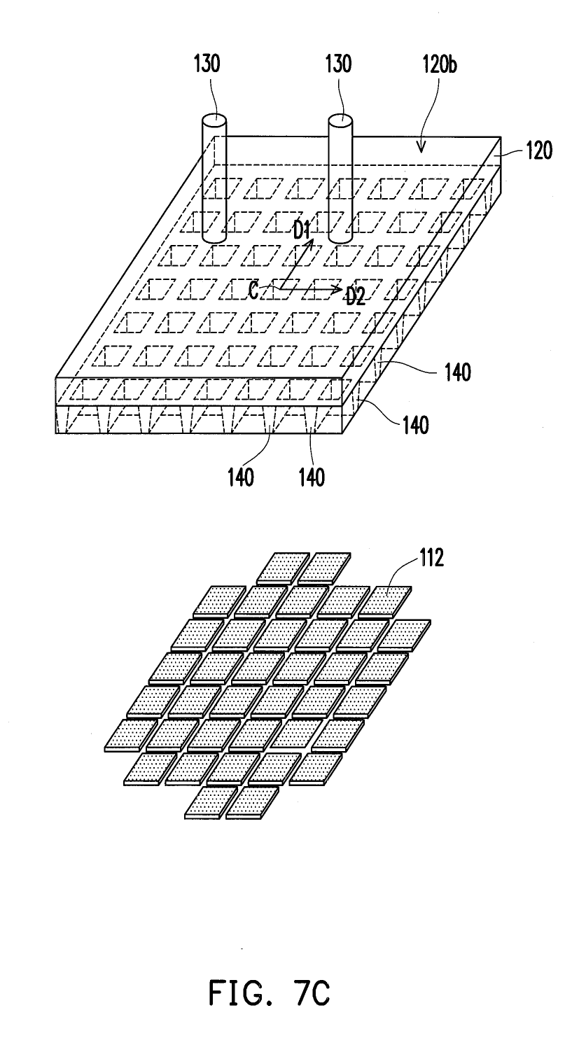

FIGS. 7A to 7C illustrate a schematic diagram of a wafer splitting process according to an embodiment of the invention. Referring to FIGS. 7A to 7C in sequence, the wafer splitting process of the present embodiment includes the following process. Referring to FIG. 7A, firstly, a wafer 110 having a plurality of chip regions R is provided. For instance, in the present embodiment, the chip regions R are arranged on the wafer 110 in an array, for example, and a plurality of edges of each of the chip regions R are substantially connected to a plurality of edges of adjacent chip regions R.

Referring to FIGS. 7B and 7C, thereafter, a splitting knife body 120 is knocked by at least one vibrating hammer 130 in a direction toward the wafer 110 for the splitting knife body 120 to move toward the wafer 110 and split the chip regions R into a plurality of independent dice 112. Further, in the present embodiment, the number of vibrating hammers 130 is, for example, plural (two vibrating hammers 130 are shown in the figure as an example). The splitting knife body 120 has a second surface 120b facing the vibrating hammers 130. The step of knocking the splitting knife body 120 with the vibrating hammers 130 includes substantially knocking the second surface 120b simultaneously and dispersively by the vibrating hammers 130. It should be illustrated that when the vibrating hammers 130 knock on the second surface 120b simultaneously and dispersively, the splitting knife body 120 more favorably splits the wafer 110 into a plurality of independent dice 112.

It should be noted that in the present embodiment, when the splitting knife body 120 moves toward the wafer 110, a plurality of knife edges 140 knocks on a plurality of boundaries of the chip regions R. For example, the knife edges 140 are in grids and when the splitting knife body 120 moves toward the wafer 110, the knife edges 140 knock on all boundary lines L of the chip regions R. Hence, when the knife edges 140 knock on all of the boundary lines L in the chip regions R, all of the chip regions R in the wafer 110 are split into a plurality of independent dice 112 simultaneously, so that the time and cost for fabricating the dice 112 can be reduced effectively.

However, the invention is not limited thereto, a plurality of knife edges 140′ in another embodiment of the invention is in dots and when the splitting knife body 120 moves toward the wafer 110, the knife edges 140′ knock on all intersection points Q of all of the boundary lines L in the chip regions R. Hence, when the knife edges 140′ knock on all of the intersection points Q of all of the boundary lines L in the chip regions R, all of the chip regions R in the wafer 110 are split into a plurality of independent dice 112 simultaneously, so that the time and cost for fabricating the dice 112 can be reduced effectively.

In yet another embodiment of the invention, the knife edges 140″ are in cross-shaped form and when the splitting knife body 120 moves toward the wafer 110, the knife edges 140″ knock on all of the intersection points Q of all of the boundary lines L in the chip regions R. Similarly, when the knife edges 140″ knock on all of the intersection points Q of all of the boundary lines L in the chip regions R, all of the chip regions R in the wafer 110 are split into a plurality of independent dice 112 simultaneously, so that the time and cost for fabricating the dice 112 can be reduced effectively.

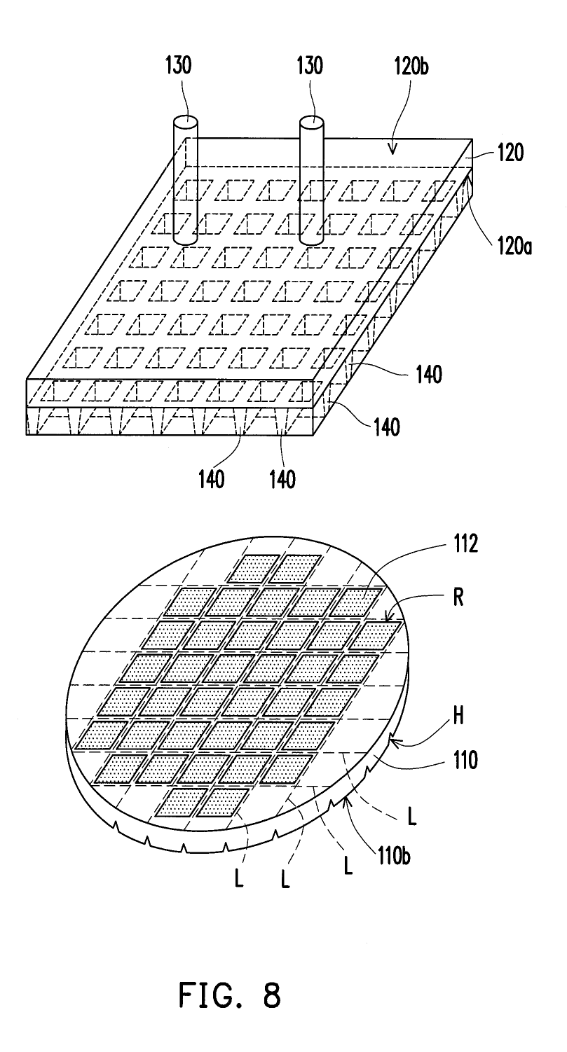

Moreover, in the wafer splitting process of the present embodiment, the wafer 110 has a first wafer surface 110a facing the splitting knife body 120 and a second wafer surface 110b facing away from the splitting knife body 120. The wafer splitting process in the present embodiment can further include the following process. Referring to FIG. 8, in the process, before the splitting knife body 120 is knocked by the vibrating hammers 130 in a direction toward the wafer 110, a plurality of notches H is etched on the second wafer surface 110b along the boundary lines L in the chip regions R by a laser beam. It should be noted that the boundary lines L overlapped with the notches H are the positions of the wafer 110 to be knocked by the knife edges 140 (or the knife edges 140′ or the knife edges 140″). Therefore, when the knife edges 140 (or the knife edges 140′ or the knife edges 140″) knock on the boundary lines L on the wafer 110, the notches H effectively facilitate the knife edges 140 (or the knife edges 140′ or the knife edges 140″) for splitting the wafer 110 into a plurality of independent dice 112. Nevertheless, the invention is not limited thereto, in other embodiments, a plurality of notches can be etched on the first wafer surface 110a along the boundary lines L in the chip regions R by a laser beam. The notches on the first wafer surface 110a can effectively facilitate the knife edges 140 (or the knife edges 140′ or the knife edges 140″) for splitting the wafer 110 into a plurality of independent dice 112.

### Second Embodiment

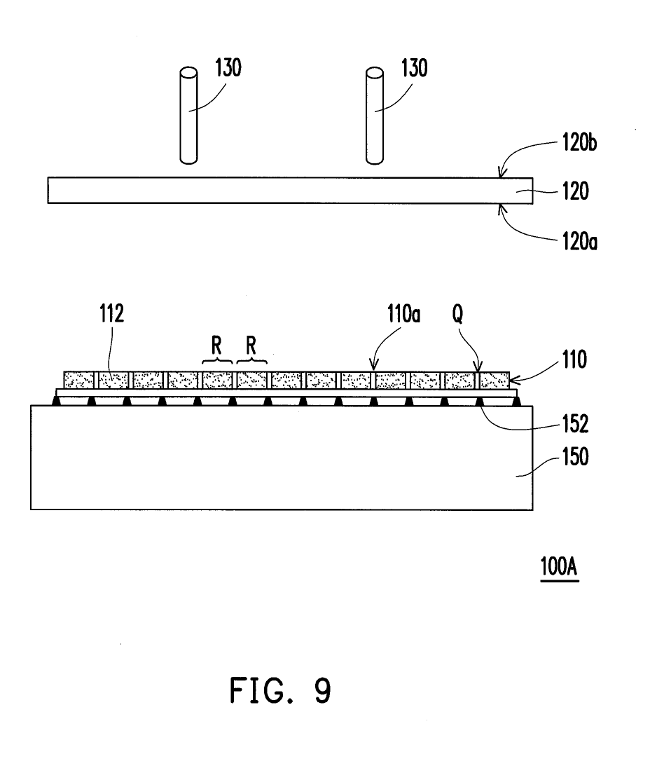

FIG. 9 illustrates a schematic diagram of a wafer splitting apparatus in a second embodiment of the invention. Referring to FIG. 9, a wafer splitting apparatus 100A in the present embodiment is similar to the wafer splitting apparatus 100 in the first embodiment, the similarities between the two are omitted hereinafter and the differences are illustrated below.

The wafer splitting apparatus 100A of the present embodiment is suitable for splitting a plurality of chip regions R in a wafer 110 into a plurality of independent dice 112. The wafer splitting apparatus 100A of the present embodiment includes a splitting knife body 120 and at least one vibrating hammer 130. The splitting knife body 120 of this embodiment is disposed at one side of the wafer 110 and has a first surface 120a facing the wafer 110. The first surface 120a stretches over a plurality of chip regions R of the wafer 110 in all extending directions of the first surface 120a passing through a center of the first surface 120a (not shown). For instance, the splitting knife body 120 in the present embodiment is a plate covering the entire wafer 110.

In the present embodiment, the splitting knife body 120 is disposed between the wafer 110 and the at least one vibrating hammer 130. The vibrating hammer 130 is suitable for knocking the splitting knife body 120 in a direction toward the wafer 110 for the splitting knife body 120 to move toward the wafer 110 so as to split the chip regions R into the dice 112. The wafer splitting apparatus 100A of the present embodiment further includes a wafer carrier 150. The wafer carrier 150 is configured to carry the wafer 110. The wafer 110 is suitable to be disposed between the wafer carrier 150 and the splitting knife body 120.

Particularly, a plurality of micro-protrusions 152 is disposed on the wafer carrier 150. The wafer 110 is disposed on the micro-protrusions 152. When the splitting knife body 120 moves toward the wafer 110, the first surface 120a knocks on the wafer carrier 150 entirely. The micro-protrusions 152 exert a force on the boundaries of the chip regions R for the chip regions R to be split into the independent dice 112. For example, in the present embodiment, the positions of the micro-protrusions 152 can be aligned with a plurality of intersection points Q of all boundary lines L (not shown) in the chip regions R. Thus, when the splitting knife body 120 moves toward the wafer 110, the micro-protrusions 152 exert a force on the intersection points Q so as to split the chip regions R into the independent dice 112. Accordingly, when the micro-protrusions 152 knock on the intersection points Q, all of the chip regions R in the wafer 110 are split into a plurality of independent dice 112 at once. In other words, a plurality of independent dice 112 can be split simultaneously through the wafer splitting apparatus 100A of the present embodiment without the multiple splitting processes carried out in conventional technology.

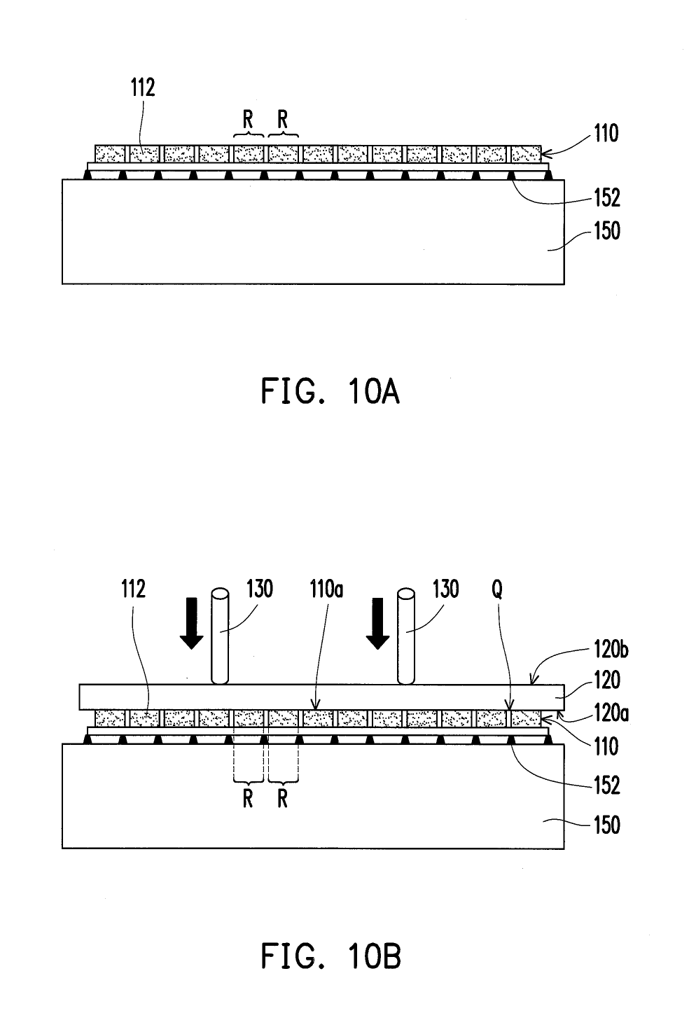

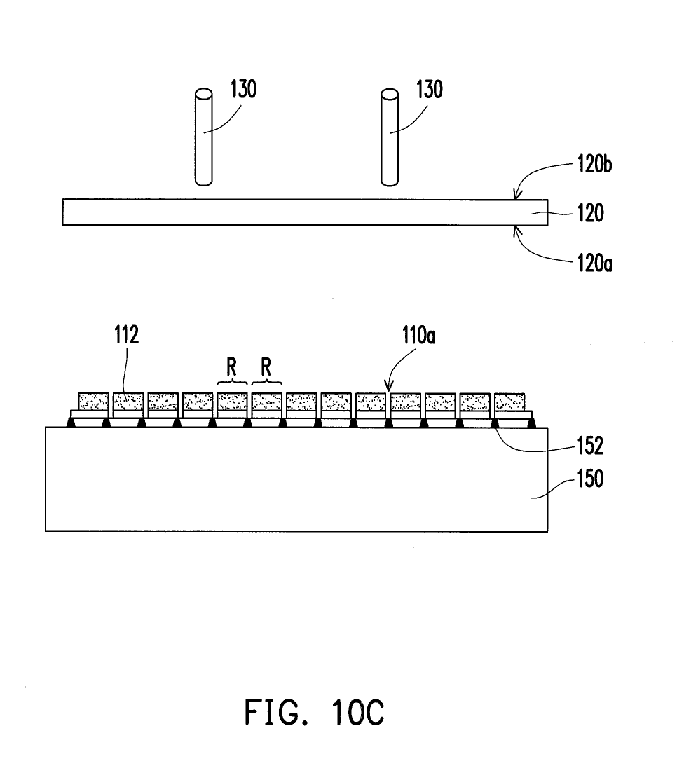

FIGS. 10A to 10C illustrate a schematic diagram of a wafer splitting process in the present embodiment. Referring to FIGS. 10A to 10C in sequence, the wafer splitting process of the present embodiment includes the following process. Referring to FIG. 10A, firstly, a wafer 110 having a plurality of chip regions R is provided. Referring to FIGS. 10B and 10C, thereafter, a splitting knife body 120 is knocked by at least one vibrating hammer 130 in a direction toward the wafer 110 for the splitting knife body 120 to move toward the wafer 110 and split the chip regions R into a plurality of independent dice 112.

The wafer splitting process of the present embodiment further includes placing the wafer 110 on the wafer carrier 150 before knocking the splitting knife body 120 with the vibrating hammer 130 in the direction toward the wafer 110. In details, the step of placing the wafer 110 on the wafer carrier 150 includes disposing the wafer 110 on the micro-protrusions 152 (as shown in FIG. 10A). When the splitting knife body 120 moves toward the wafer 110, the first surface 120a knocks on the wafer carrier 150 entirely (as shown in FIG. 10B). Moreover, the micro-protrusions 152 exert a force on the boundaries of the chip regions R so as to split the chip regions R into the dice 112. Accordingly, when the first surface 120a knocks on the wafer carrier 150 entirely, all of the wafer regions R in the wafer 110 are split into a plurality of independent dice 112 simultaneously, such that the time and cost for fabricating the dice 112 can be reduced effectively.

It should be noted that after the wafer 110 is placed on the wafer carrier 150 and before the vibrating hammer 130 knocks the splitting knife body 120 in the direction toward the wafer 110, a protection film can be disposed on the first wafer surface 110a of the wafer 110 facing the splitting knife body 120 before the splitting knife body 120 moves toward the wafer 110. The protection film can protect the wafer 110, such that when the first surface 120a knocks the wafer carrier 150 entirely, the first wafer surface 110a of the wafer 110 is not damaged easily.

In summary, as the splitting knife body of the embodiments in the invention includes a plurality of knife edges, when the splitting knife body splits the wafer, the knife edges correspond to the positions of the boundaries of the chip regions. Consequently, the splitting knife body is capable of splitting a plurality of chip regions on the wafer into a plurality of dice simultaneously. The time for fabricating the dice can thus be reduced greatly, thereby reducing the fabrication cost of the dice.

In addition, the wafer carrier of the embodiments in the invention includes a plurality of micro-protrusions thereon, and when the splitting knife body splits the wafer, the micro-protrusions correspond to the positions of the boundaries of the chip regions. Hence, when the splitting knife body knocks on the wafer carrier, the micro-protrusions can split the chip regions on the wafer into a plurality of independent dice. The time for fabricating the dice can therefore be reduced greatly so as to reduce the fabrication cost of the dice effectively.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A wafer splitting apparatus suitable for splitting a plurality of chip regions in a wafer into a plurality of independent dice, the wafer splitting apparatus comprising:
a splitting knife body disposed at one side of the wafer and having a first surface facing the wafer, wherein the first surface stretches over a plurality of chip regions of the wafer in all extending directions of the first surface passing through a center of the first surface; and
at least one vibrating hammer, wherein the splitting knife body is disposed between the wafer and the vibrating hammer, and the vibrating hammer is suitable for knocking the splitting knife body in a direction toward the wafer for the splitting knife body to move toward the wafer so as to split the chip regions into the dice.

2. The wafer splitting apparatus as claimed in claim 1, further comprising a plurality of knife edges disposed on the first surface, wherein when the splitting knife body moves toward the wafer, the knife edges knock on a plurality of boundaries of the wafer regions.

3. The wafer splitting apparatus as claimed in claim 2, wherein the knife edges are in grids and when the splitting knife body moves toward the wafer, the knife edges knock on all boundary lines of the chip regions.

4. The wafer splitting apparatus as claimed in claim 2, wherein the knife edges are in dots and when the splitting knife body moves toward the wafer, the knife edges knock on intersection points of all boundary lines of the chip regions.

5. The wafer splitting apparatus as claimed in claim 2, wherein each of the knife edges is in cross-shaped form and when the splitting knife body moves toward the wafer, the knife edges knock on intersection points of all boundary lines of the chip regions.

6. The wafer splitting apparatus as claimed in claim 1, further comprising a wafer carrier configured to carry the wafer, wherein the wafer is suitable to be disposed between the wafer carrier and the splitting knife body.

7. The wafer splitting apparatus as claimed in claim 6, wherein the wafer carrier comprises a plurality of micro-protrusions thereon, the wafer is disposed on the micro-protrusions and when the splitting knife body moves toward the wafer, the first surface knocks on the wafer carrier entirely and the micro-protrusions exert a force to a plurality of boundaries of the chip regions for splitting the chip regions into the dice.

8. The wafer splitting apparatus as claimed in claim 1, wherein the at least one vibrating hammer is a plurality of vibrating hammers, the splitting knife body has a second surface facing the vibrating hammers, and the vibrating hammers are substantially suitable for knocking on the second surface simultaneously and dispersively.

9. A wafer splitting process, comprising:
providing a wafer, wherein the wafer has a plurality of chip regions; and
knocking a splitting knife body by at least one vibrating hammer in a direction toward the wafer for the splitting knife body to move toward the wafer and split the chip regions into a plurality of independent dice, wherein the splitting knife body has a first surface facing the wafer and the first surface stretches over the chip regions of the wafer in all extending directions of the first surface passing through a center of the first surface.

10. The wafer splitting process as claimed in claim 9, wherein a plurality of knife edges is disposed on the first surface of the splitting knife body and when the splitting knife body moves toward the wafer, the knife edges knock on a plurality of boundaries of the wafer regions.

11. The wafer splitting process as claimed in claim 10, wherein the knife edges are in grids and when the splitting knife body moves toward the wafer, the knife edges knock on all boundary lines of the chip regions.

12. The wafer splitting process as claimed in claim 10, wherein the knife edges are in dots and when the splitting knife body moves toward the wafer, the knife edges knock on intersection points of all boundary lines of the chip regions.

13. The wafer splitting process as claimed in claim 10, wherein each of the knife edges is in cross-shaped form and when the splitting knife body moves toward the wafer, the knife edges knock on intersection points of all boundary lines of the chip regions.

14. The wafer splitting process as claimed in claim 9, further comprising:
before knocking the splitting knife body by the at least one vibrating hammer in the direction toward the wafer, placing the wafer on a wafer carrier.

15. The wafer splitting process as claimed in claim 14, wherein the wafer carrier comprises a plurality of micro-protrusions thereon and a step of disposing the wafer on the wafer carrier comprises disposing the wafer on the micro-protrusions, wherein when the splitting knife body moves toward the wafer, the first surface knocks on the wafer carrier entirely and the micro-protrusions exert a force to a plurality of boundaries of the chip regions for splitting the chip regions into the dice.

16. The wafer splitting process as claimed in claim 9, wherein the wafer has a first wafer surface facing the splitting knife body and a second wafer surface facing away from the splitting knife body, the wafer splitting process further comprising:
before knocking the splitting knife body by the at least one vibrating hammer in the direction toward the wafer, etching a plurality of notches on the second wafer surface along a plurality of boundary lines of the chip regions by a laser.

17. The wafer splitting process as claimed in claim 9, wherein the at least one vibrating hammer is a plurality of vibrating hammers, the splitting knife body has a second surface facing the vibrating hammers, and a step of knocking the splitting knife body by the vibrating hammers in the direction toward the wafer comprises knocking the second surface substantially with the vibrating hammers simultaneously and dispersively.
